(19) United States
(12) Patent Application Publication
(10) Pub. No.: US 2015/0219241 A1
(43) Pub. Date: Aug. 6, 2015

(54) WARNING DEVICE FOR DETERMINING WATER FLOW STATUS

(71) Applicant: ZHONGSHAN QINGYI METAL PRODUCTS ENTERPRISE CO., LTD., Guangdong Province (CN)

(72) Inventor: TANG-CHIEH YU, TAICHUNG CITY (TW)

(73) Assignee: ZHONGSHAN QINGYI METAL PRODUCTS ENTERPRISE CO., LTD., Guangdong Province (CN)

(21) Appl. No.: 14/173,990

(22) Filed: Feb. 6, 2014

(51) Int. Cl. F16K 37/00; G08B 5/36

(52) U.S. Cl. CPC F16K 37/005; G08B 5/36

(57) ABSTRACT

A warning device for determining water flow status includes a main body having a flow channel penetrating through both ends of the main body and an opening on a side of the main body, and an intersection of the flow channel and the opening define a working chamber. The working chamber includes a power generating device with a pivoting turbine blade and a light emitting element. The turbine blade is pushed by water flow to generate electric power to the light emitting element to emit light. The power generating device includes a flow diverting element having a slot compartment formed by a shaft cover and a sidewall, and the turbine blade is disposed therein. A plurality of flow diverting holes are disposed on the flow diverting element for flowing water into the slot compartment to push and move the turbine blade.

### BACKGROUND OF THE INVENTION

1. Field of the Invention

The present invention relates to a warning device, and more particularly to the warning device for determining water flow status.

2. Description of Related Art

When using sprinklers in lawns and squares nighttime, it is inconvenient for users to determine whether or not there is water flowing out from the sprinklers. In general, users have to come near the sprinklers and check them out one by one, and if the sprinklers are buried underground, it will become more difficult for the users to determine whether there is water flowing out from the sprinklers. Therefore, a conventional sprinkler with a signal light installed at a connector of the sprinkler and provided for indicating the using status and water flow of the sprinkler. However, signal lights of this sort require a battery or an external power supply, and the battery or power supply must be replaced when the electric power is exhausted. Obviously, such conventional sprinkler is inconvenient to use.

### SUMMARY OF THE INVENTION

In view of the aforementioned problem of the prior art, it is a primary objective of the present invention to provide a warning device for determining water flow status, wherein a water flow driven light emitting element is provided for emitting light to achieve a warning effect, so that users can know about the using status of a sprinkler.

To achieve the aforementioned objective, the present invention provides a warning device for determining water flow status, comprising:

a main body, including a flow channel formed in the main body and penetrating through both ends of the main body to form a water outlet end and a water inlet end, and an opening formed on a side of the flow channel and facing the main body, and an intersection of the flow channel and the opening defining and forming a working chamber;

a power generating device, fixed into the working chamber, and having pivoting turbine blade, and including a light emitting element, so that a water flow can push the turbine blade to generate electric power to be supplied to the light emitting element to emit light;

a flow diverting element, installed on the power generating device, and including a slot compartment formed and enclosed by a shaft cover, and the turbine blade of the flow diverting element covering and being disposed in the slot compartment, wherein the flow diverting element includes a plurality of flow diverting holes provided for flowing water from the flow diverting holes into the slot compartment to push and move the turbine blade; and

a cover, being translucent, and installed and sealed onto the opening of the main body.

Preferably, the flow channel includes a fixed portion disposed on a peripheral wall of the flow channel and provided for fixing the power generating device onto the fixed portion.

Preferably, the cover has a thread section screwed and secured to the opening.

Preferably, the power generating device includes a waterproof casing.

The above and other objects, features and advantages of the present invention will become apparent from the following detailed description taken with the accompanying drawings.

### BRIEF DESCRIPTION OF THE DRAWINGS

FIG. 1 is an exploded view of the present invention;

FIG. 2 is a sectional view of the present invention; and

FIG. 3 is a sectional view of Section A-A of FIG. 2.

### DETAILED DESCRIPTION OF THE PREFERRED EMBODIMENTS

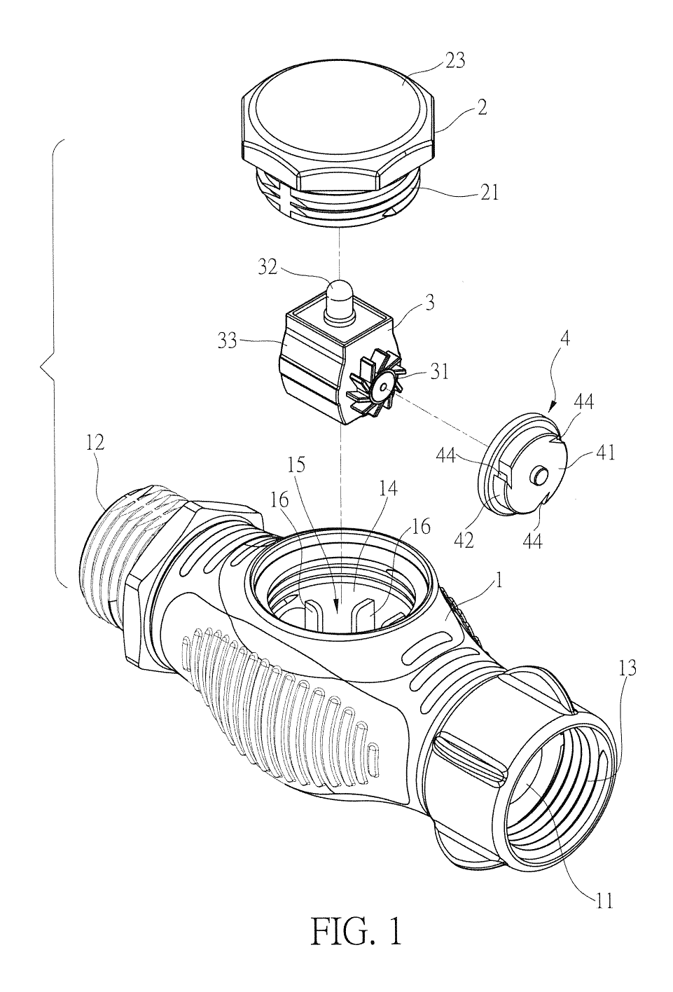

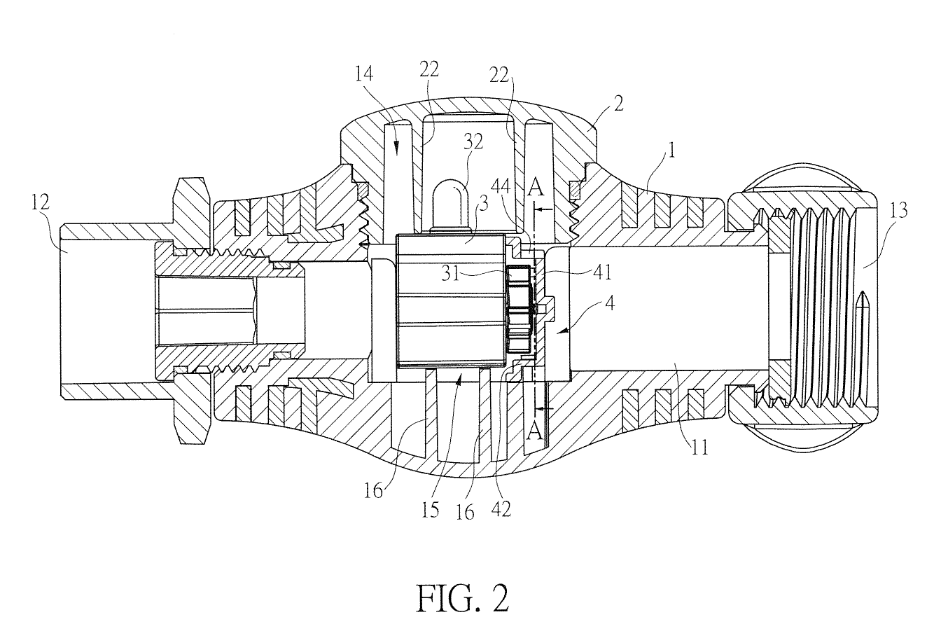

With reference to FIGS. 1 and 2 for a warning device for determining water flow status in accordance with a preferred embodiment of the present invention, the warning device is applicable for determining whether or not water flows through a pipeline of water pipes, and the warning device is applied in a sprinkler in this preferred embodiment. The warning device comprises a main body 1 including a flow channel 11 formed in the main body 1 and penetrating through both ends of the main body 1 to form a water outlet end 12 and a water inlet end 13, such that after the water pipes are connected, water flows in the flow channel 11 from the water inlet end 13 and then flows through out from the water outlet end 12. The flow channel 11 further has an opening 14 formed on a side of the main body 1, and an intersection of the flow channel 11 and the opening 14 forms a working chamber 15, and a cover 2 is installed at the opening 14. In this preferred embodiment, the cover 2 has a thread section 21 screwed and secured to the opening 14 for sealing the opening 14.

The working chamber 15 has a power generating device 3 fixed therein. In this preferred embodiment, the flow channel 11 has a fixed portion 16 protruded from a peripheral wall of the flow channel 11 and facing the working chamber 15 and provided for fixing the power generating device 3 onto the fixed portion 16. In addition, the cover 2 further has a positioning portion 22 protruded from the cover 2 and facing the working chamber 15, and the positioning portion 22 abuts against the power generating device 3 for a fixation. Since the fixed portion 16 and the positioning portion 22 jointly clamp the power generating device 3, the power generating device 3 is secured and positioned in the working chamber 15.

The power generating device 3 may be a compact turbine generator having a pivoting turbine blade 31 and driven by water flow to generate electric power. In this preferred embodiment, the power generating device 3 has a waterproof casing 33, and the turbine blade 31 is installed on a side of the power generating device 3 that faces the water inlet end 13. The power generating device 3 further includes a light emitting element 32, wherein the light emitting element 32 of this preferred embodiment is a light emitting diode (LED), and the electric power required for the light emission of the LED is supplied by the power generating device 3. On the other hand, the light emitting element 32 is installed at a position proximate to the cover 2, and the cover 2 has a top portion 23, wherein the cover 2 of this preferred embodiment is made of a translucent material, so that the light produced by the light emitting element 32 can pass through the cover 2, and users can see the indicating light. Of course, the cover 2 may only have the top portion 23 made of a translucent material.

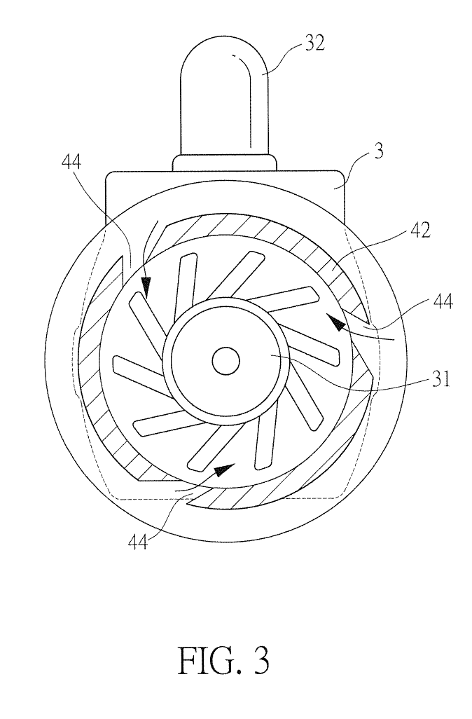

In addition, the power generating device 3 has a flow diverting element 4 installed thereon, and the flow diverting element 4 is installed on a sidewall 42 around the periphery of a shaft cover 41, and a slot compartment 43 is formed between the shaft cover 41 and the sidewall 42. The flow diverting element 4 is provided for covering the turbine blade 31 into the slot compartment 43, and the flow diverting element 4 has a plurality of flow diverting holes 44. In this preferred embodiment, the flow diverting holes 44 are formed on the sidewall 42 and provided for radially flowing water into the slot compartment 43 from the water inlet end 13 through the flow diverting holes 44 of the sidewall 42 as shown in FIG. 3 to push and move the turbine blade 31 in order to drive the power generating device 3 to generate electric power to the light emitting element 32 for the light emission.

With the aforementioned components of the assembly, the present invention has the following advantages. The electric power required for the light emission of the light emitting element 32 no longer requires an external power supply, but the sprinkler is capable of generating the power on its own during use. More specifically, as long as the control valve of the sprinkler is opened to allow water to flow through the flow channel 11, the water flow can be used to push and move the turbine blade 31 of the power generating device 3 to generate electric power, so as to timely supply the electric power to the light emitting element 32 for the light emission, and users can recognize the light and know about the using status of the sprinkler. After the use of the sprinkler is completed, and the control valve is shut, the water flow will stop immediately and will not push the turbine blade 31 anymore, and the light of the light emitting element 32 will be off while the electric power is disconnected. The present invention provides an indicating device to indicate the using status of the sprinkler immediately, so as to prevent spraying too much water and achieve the effect of saving water resources.

1. A warning device for determining water flow status, comprising:
a main body, including a flow channel formed in the main body and penetrating through both ends of the main body to form a water outlet end and a water inlet end, and an opening formed on a side of the main body, and an intersection of the flow channel and the opening defining and forming a working chamber;
a power generating device, fixed into the working chamber, and having pivoting turbine blade, and including a light emitting element, so that a water flow can push the turbine blade to generate electric power to be supplied to the light emitting element to emit light;
a flow diverting element, installed on the power generating device, and including a slot compartment formed by a shaft cover and a sidewall, and the turbine blade being covered into the slot compartment with the flow diverting element, wherein the flow diverting element includes a plurality of flow diverting holes provided for flowing water from the flow diverting holes into the slot compartment to push and move the turbine blade; and
a cover, being translucent, and installed and sealed onto the opening of the main body.

2. The warning device for determining water flow status according to claim 1, wherein the flow channel includes a fixed portion disposed on a peripheral wall of the flow channel and provided for fixing the power generating device onto the fixed portion.

3. The warning device for determining water flow status according to claim 2, wherein the cover includes a positioning portion abutting against the power generating device for a fixation.

4. The warning device for determining water flow status according to claim 1, wherein the flow diverting hole is formed on the sidewall of the flow diverting element for radially flowing water from the flow diverting hole into the slot compartment to push and move the turbine blade.

5. The warning device for determining water flow status according to claim 1, wherein the cover has a thread section screwed and secured to the opening.

6. The warning device for determining water flow status according to claim 1, wherein the light emitting element is a light emitting diode (LED).

7. The warning device for determining water flow status according to claim 1, wherein the power generating device includes a waterproof casing.
